(19) United States
(12) Patent Application Publication
(10) Pub. No.: US 2024/0347233 A1
(43) Pub. Date: Oct. 17, 2024

(54) SEQUENTIAL TWISTING DEVICE

(71) Applicant: Komax Holding AG, Dierikon (CH)

(72) Inventors: Urs Dober, Kussnacht (CH); Flavio Blum, Emmenbrucke (CH)

(21) Appl. No.: 18/628,859

(22) Filed: Apr. 8, 2024

(30) Foreign Application Priority Data
Apr. 14, 2023 (EP) 23167892.1

(51) Int. Cl. H01B 13/02; H01B 13/00

(52) U.S. Cl. CPC H01B 13/0228; H01B 13/0036

(57) ABSTRACT

A cable processing machine produces a predefined sequence of twisted cable groups. The cable processing machine has a control unit, a cable tip processing system for processing a cable, a handling system, and a twisting station.

### FIELD

The present invention relates to a cable processing machine. In particular, the invention relates to a cable processing machine which can produce both single cables and twisted or stranded cable groups, for example twisted cable pairs, in a predetermined sequence.

### BACKGROUND

A cable group can comprise a multiplicity of group cables. A twisted cable group can have a multiplicity of group cables that are twisted or stranded together. A twisting can in particular mean the rotation of a multiplicity of group cables, for example the rotation of a cable pair, as a whole. During twisting, a plurality of cables (group cables) can be wound against one another. A stranding can mean, in particular, that the individual group cables themselves are rotated and additionally the multiplicity of group cables is rotated as a whole. In particular, the direction of rotation of the rotated individual group cables can be opposite to the direction of rotation of the cable group. Advantageously, the load can be reduced by the rotation onto the individual group cable. In the following, the term “twisting” is substantially used, but it can also be understood as “stranding”. The advantages in signal transmission make twisted cable groups or stranded cable groups more and more indispensable for modern cable harnesses that have to transmit a multiplicity of signals and data.

Pre-twisted cable groups are a relatively expensive starting material for cable assemblers due to the additional processing step. Machines are known that cut commercially available, untwisted cables to length, attach contact parts, twist or strand them, and output them in stretched form. These machines are optimized for large quantities and produce in fixed batch sizes. This results in an attempt to produce the same twisted cable group (e.g. with the same combination of the group cables) for as long as possible. Such machines are set up in particular to produce large runs of identical twisted cable groups (cable harnesses).

Simple machines are also known which twist or strand two or three group cables together. Here the group cables are cut to the desired length. Frequently, the cable ends are also already processed.

Machines are known which are optimized to produce a sequence of different single cables. At the end of such a machine, for example, all cables required for a specific cable harness have been provided. If a connector assembly module is connected to such a machine, a cable harness with wired connectors can be taken from it.

Due to the design, and in particular due to the manufacturing steps, the cables in such a machine are laid in loops and moved in this form to the processing stations. A twisting of cables in loop form is technically feasible, but a continuous rotation from one end to the other is hardly possible, since for this purpose the reversal point of the loop would have to be displaced from one end to the other. According to the conventional wisdom, twisting with a clearly defined rotation point can hardly be realized economically for cables in loop form.

### SUMMARY

An object of the present invention is to provide a cable processing machine which is designed for the flexible and simple production of cable sets and/or cable harnesses.

This object is achieved by the cable processing machine and by the method according to the advantageous embodiments that are recited in the following description.

A first aspect of the invention relates to a cable processing machine for producing a predefined sequence of twisted cable groups, wherein the cable processing machine has a control unit, a cable tip processing system for processing a cable, a handling system, and a twisting station. The predefined sequence can be determined by means of the control unit. The cable tip processing system has a processing unit, an ejection gripper and a transport unit. The transport unit is designed to move a looped cable from the processing unit to the ejection gripper. The ejection gripper is set up to provide the looped cable to the downstream handling system.

The handling system has a transfer unit for receiving a plurality of looped cables and is designed and arranged to receive the looped cable received from the ejection gripper as one of the plurality of looped cables in the transfer unit. The plurality of looped cables form a looped cable group. The handling system is designed to supply the looped cable group to the twisting station. The twisting station is designed and arranged to receive the looped cable group and to twist it so that a looped twisted cable group results.

The control unit is set up to assign a respective multiplicity of group cables for each of the twisted cable groups of the predefined sequence and to control the cable processing machine in order to, for each group cable of the respective multiplicity of group cables as a respectively looped cable,
move it from the processing unit to the ejection gripper by means of the transport unit,
provide it to the downstream handling system by means of the ejection gripper,
and receive it from the transfer unit,
   and in order to supply the multiplicity of group cables received in the transfer unit as looped cables to the twisting station, to receive them from the twisting station and to twist them, so that the looped twisted cable group results, and to feed the looped twisted cable group to a following station according to the predefined sequence.

A cable extends between a first cable end and a second cable end. A cable end can also be referred to as a cable tip.

A looped cable can also be referred to as a cable laid in a loop. In a looped cable, the first cable end and the second cable end can point in the same direction. In particular, in a looped cable the first cable end and the second cable end run parallel to one another. The looped cable can extend in a U-shape between the first cable end and the second cable end. A looped cable can have a loop base. The loop base can be arranged between the first cable end and the second cable end.

The first cable end and the second cable end of a looped cable can be pivoted so that a pivoted looped cable is produced. In particular, the first cable end and the second cable end can be pivoted in such a way that they point away from each other. In a pivoted looped cable, the first cable end and the second cable end can be arranged on a common axis and point in opposite directions. The loop base can be located between the two cable ends and protrude from the common axis.

A cable group comprises a multiplicity of group cables. A cable group can in particular comprise two, three, or four group cables. In particular, a cable group comprises two group cables. A first group cable of a cable group can differ from a second group cable of a cable group. In an embodiment, all group cables of a cable group differ from one another.

A looped cable group can have a multiplicity of group cables. The transfer unit can receive a multiplicity of looped cables, in particular a multiplicity of pivoted looped cables which form a looped cable group.

In a looped cable group, the first cable ends of the group cables can point in a first direction and the second cable ends of the group cables can point in the opposite, second direction. The entirety of the first cable ends of the group cables can also be referred to as the first group end. The entirety of the second cable ends of the group cables can also be referred to as the second group end.

The twisting station can be designed to twist the group cables of the looped cable group and to produce a twisted looped cable group.

In a twisted looped cable group, the first group ends and the second group ends can point in the same direction. The first group ends can extend parallel to the second group ends.

In an embodiment, the order of twisted cable groups is defined in the predefined sequence of twisted cable groups. The predefined sequence of twisted cable groups can be an individualized sequence. The sequence of twisted cable groups can be defined in the predefined sequence of twisted cable groups. The sequence of the group cables of the twisted cable groups can be defined in the predefined sequence of twisted cable groups. In particular, the sequence comprises a multiplicity of different twisted cable groups. In particular, the sequence comprises a multiplicity of group cables of the twisted cable groups.

The sequence of twisted cable groups can comprise at least a first twisted cable group and a second twisted cable group, wherein the first twisted cable group is different from the second twisted cable group. In an embodiment, the first twisted cable group differs from the second twisted cable group in at least one of the following properties: the combination of the group cables of the cable groups, the cable length of the cable group, the cable lengths of the group cables, the diameter of the cable group, the diameter of a group cable of the cable group, the color of the cable group, the color of a group cable of the cable group, the contact parts of the cable group, the number of group cables in the cable group, the lay length of the twisted cable group, the twist angle of the twisted cable group, the turn spacing of the twisted cable group, the stranding factor. The lay length can also be referred to as the twist.

In an embodiment, the predefined sequence comprises the twisted cable groups of a specified cable harness. In an embodiment, the predefined sequence comprises the twisted cable groups of a specified cable set.

In an embodiment, the cable processing machine is set up to produce a predefined order of different twisted cable groups. The production of a cable harness or a cable set is advantageously simplified, since all twisted cable groups are produced by the cable processing machine in the predefined order. Pre-twisted cable groups or a pre-production of the required twisted cable groups, which are then combined in the desired order using an additional device, is not required. The costs of producing a cable harness or a cable set can advantageously be reduced.

The control unit can be set up to control (e.g. control or regulate) the cable processing machine.

In an embodiment, the control unit is set up to control the cable processing machine to move each group cable sequentially as a respectively looped cable by means of the transport unit from the processing unit to the ejection gripper, to provide it to the downstream handling system by means of the ejection gripper, and to receive it from the transfer unit.

The cable processing machine can process the group cables one after the other according to the predefined sequence and provide them to a following station. In an embodiment, the cable processing machine can process the cables continuously. In an embodiment, the cable processing machine can be designed to process a multiplicity of cables simultaneously. For example, the cable processing machine can be set up to twist a cable group in the twisting station and simultaneously process a looped cable in the processing station. Continuous production can advantageously be enabled.

In an embodiment, the cable processing machine is made up of a cable tip processing system or station, a twisting station, and a handling system which connects the cable tip processing station and the twisting station and can pass on the finished cables. The cable tip processing station can also be referred to as a cable tip processing device. The cable tip processing device can also be referred to as cable end processing or as a cable end processing device.

The twisting station can also be referred to as a twisting unit.

A transport unit can transport the looped cable so that the first cable end and the second cable end can be processed by the processing station. Since both cable ends point in the same direction, the processing can be carried out quickly. In this way, the production time can be reduced.

In an embodiment, the predefined sequence additionally contains a single cable. In an embodiment, the predefined sequence additionally contains at least one single cable. In the embodiment, the handling system is designed to feed the looped cable to the following station as a single cable in accordance with the predefined sequence, wherein the control unit is set up to assign an individual cable to the single cable of the predefined sequence and to control the cable processing machine in order to move the individual cable as a looped cable by means of the transport unit from the processing unit to the ejection gripper, to provide it to the downstream handling system by means of the ejection gripper, and to feed it to the following station as a single cable in accordance with the predefined sequence.

The predefined sequence can have at least one single cable and a multiplicity of twisted cable groups. In the predefined sequence, a twisted cable group can be followed by another twisted cable group. In the predefined sequence, a twisted cable group can be followed by a single cable. In the predefined sequence, a single cable can be followed by a twisted cable group. In the predefined sequence, a single cable can be followed by another single cable. This advantageously enables increased flexibility during production. Advantageously, the cable processing machine can be designed to produce different cable sets and/or cable harnesses.

In an embodiment, the handling system (also called auxiliary station) is arranged at the end of the cable tip processing (also referred to as a sequence machine). In an embodiment, the auxiliary station allows finished single lines (single cables) to be passed on. The auxiliary station can transfer prepared cable groups, in particular cable pairs, to the connected twisting station (also known as the stranding station) and receive them again after this process step.

In an embodiment, the cable processing machine is set up to produce both single cables and twisted or stranded cable groups in a desired sequence. Here the sequence can be made up of cables that differ not only in length, but also in other aspects (e.g. cable type, diameter, color, contact parts, lay length for twisted or stranded cables, etc.).

### Twisting Station:

The cable processing machine has a twisting station. The twisting station can be a stranding station. In an embodiment, the twisting station is designed to stretch the looped group cables to form a stretched cable group. In an embodiment, the twisting station is designed to displace the stretched cable group to form a stretched twisted cable group. In an embodiment, the twisting station is designed to place the stretched twisted cable group into the looped twisted cable group. In an embodiment, the twisting station is designed to stretch the looped group cable to form a stretched cable group, to twist the stretched cable group to form a stretched twisted cable group, and to place the stretched twisted cable group into the looped twisted cable group.

In an embodiment, the twisting station has a first twisting head and a second twisting head, the first twisting head being designed to rest against a first end region of the looped cable group and the second twisting head being designed to rest against a second end region of the looped cable group, wherein the first twisting head and the second twisting head are arranged along a twisting axis, wherein the first twisting head is movable in relation to the second twisting head along the twisting axis, so that a head spacing between the first twisting head and the second twisting head is variable.

The first end region can adjoin the first cable end. The first end region can adjoin the first group end. The first cable end can be surrounded by the first end region. The first group end can be surrounded by the first end region. The second end region can adjoin the second cable end. The second end region can adjoin the second group end. The second group end can be surrounded by the second end region. The second cable end can be surrounded by the second end region.

The first twisting head can grip the first group end. The second twisting head can grip the second group end. The first twisting head and the second twisting head can grip the two group ends.

The twisting station can be set up to remove the two twisting heads from one another. The first twisting head can be movable (e.g. shiftable or displaceable). The second twisting head can be movable (e.g. shiftable or displaceable). The first twisting head and/or the second twisting head can be movable along the twisting axis.

The distance between the two twisting heads can be variable, in particular the distance along the twisting axis. The distance between the two twisting heads can be variable, in particular reversibly variable. The distance between the two twisting heads can be adjustable.

The distance between the first twisting head and the second twisting head can be increased, in particular in order to stretch the group cables of the looped cable group. The distance between the two twisting heads can be reducible, in particular in order to place the twisted cable group into a loop. The control unit can be set up to control the distance between the two twisting heads. The control unit can be set up to control the distance between the two twisting heads along the twisting axis.

The group cables of the looped cable group can be stretched so that there is no longer a loop. The group cables of the looped cable group can be stretched so that they extend along the twisting axis. The stretched group cables (of the cable group) can easily be twisted to form a twisted cable group. The twisted cable group can be laid in a loop and passed on to the following station as a looped twisted cable group.

By stretching the group cables of the looped cable group, simple twisting can advantageously be enabled. After the twisting, the twisted cable group can be placed again into a loop, so that the further processing can advantageously be facilitated.

In an embodiment, the first twisting head is movable along a rail.

In an embodiment, the first twisting head and the second twisting head are movable on a rail. In particular, both twisting heads can be arranged on a common rail and can be movable along the rail. In particular, a straight, non-curved rail is provided. The rail can extend along the twisting axis. The rail can extend parallel to the twisting axis. The first twisting head and/or the second twisting head can be moved along the twisting axis. The rail can advantageously enable a simple controlled movement.

In an embodiment, the twisting station comprises a first auxiliary gripper, wherein the first auxiliary gripper is arranged and set up to grip the stretched twisted cable group at a first auxiliary distance from the first twisting head, wherein the twisting station is designed to hold the twisted cable group between the first twisting head and the first auxiliary gripper along the twisting axis when the head spacing between the first twisting head and the second twisting head is reduced, in particular when the stretched twisted cable group is placed into the looped twisted cable group.

In an embodiment, the twisting station has a second auxiliary gripper. In particular, the twisting station has a first auxiliary gripper and a second auxiliary gripper. The second auxiliary gripper can be arranged and designed to grip the stretched twisted cable group at a second auxiliary distance from the second twisting head, wherein the twisting station is designed to hold the twisted cable group between the second twisting head and the second auxiliary gripper along the twisting axis when the head distance between the first twisting head and the second twisting head is reduced.

The first auxiliary gripper can grip the stretched twisted cable group at a first auxiliary distance from the first twisting head along the twisting axis. The second auxiliary gripper can grip the stretched twisted cable group at a second auxiliary distance from the second twisting head along the twisting axis.

The region between the respective twisting head and the associated auxiliary gripper can advantageously be held stretched. The region can extend between the twisting head and the auxiliary gripper along the twisting axis, even if the cable group is placed into the loop and moves out of the twisting axis when the twisting heads are moved together. The region between the first twisting head and the first auxiliary gripper can therefore advantageously easily be accessed, in particular by the handling gripper. The first auxiliary gripper can grip at a distance from the first twisting head such that the handling gripper can gain access to the cable group at this distance. Advantageously, good access of the handling gripper can be enabled. The transfer and/or further processing of the cable group can advantageously be simplified.

The first twisting head and/or the second twisting head can be designed in particular to twist the group cables of the stretched cable group together. The group cables can be twisted about the twisting axis.

The first twisting head can be rotatable. The first twisting head can rotate about the twisting axis. The second twisting head can be rotatable. The second twisting head can rotate about the twisting axis.

In an embodiment, the cable processing machine has a separating element, wherein the separating element is arranged between a first channel and a second channel. The first channel can be arranged and designed such that the looped cable group of the twisting station can be fed through the first channel. The second channel can be arranged and designed in such a way that the looped twisted cable group can be removed from the twisting station through the second channel. The separating element can be arranged under the twisting station. The cable groups in the first channel and in the second channel can be spatially separated from one another by means of the separating element.

The separating element can be used to advantageously separate the loops of the cables (group cables) that are fed to the twisting station from the loops of the cable groups (twisted cable group) that leave the twisting station. Interaction between the incoming and outgoing cable loops can advantageously be prevented. The separating element can be set up so that it is not necessary to wait for the twisted looped cable group to be completely removed before loading the twisting station. Advantageously, the process can be accelerated, since waiting times are reduced.

The twisting station can be set up to stretch the looped cable group fed to the first channel to form a stretched cable group and to simultaneously remove it from the first channel, to twist the stretched cable group to form a stretched twisted cable group, and to place the stretched twisted cable group into the looped twisted cable group and simultaneously feed it to the second channel.

### Handling Gripper:

The cable processing machine has a handling system. In an embodiment, the handling system has a first handling gripper, wherein the first handling gripper is arranged and designed:
to feed the looped cable provided by the ejection gripper to the transfer unit, and/or
to provide the looped twisted cable group to the following station, and/or
to feed the looped cable provided by the ejection gripper to a bad cable area if the provided looped cable is recognized as a bad cable, and/or
to feed the looped twisted cable group to the bad cable area if the looped twisted cable group is recognized as a bad cable.

The first handling gripper can be arranged and designed to feed the looped cable provided by the ejection gripper to the transfer unit. The first handling gripper can be arranged and designed to provide the looped twisted cable group to the following station. The first handling gripper can be arranged and designed to feed the looped cable provided by the ejection gripper to a bad cable area if the provided looped cable is recognized as a bad cable. The first handling gripper can be arranged and designed to feed the looped twisted cable group to the bad cable area if the looped twisted cable group is recognized as a bad cable.

In an embodiment, the handling system has the first handling gripper and a second handling gripper. The second handling gripper can be arranged and designed to feed the looped cable provided by the ejection gripper to the transfer unit. The second handling gripper can be arranged and designed to make the looped twisted cable group available to the following station. The second handling gripper can be arranged and designed to feed the looped cable provided by the ejection gripper to a bad cable area if the looped cable provided is recognized as a bad cable. The second handling gripper can be arranged and designed to feed the looped twisted cable group to the bad cable area if the looped twisted cable group is recognized as a bad cable.

The handling system can be designed and arranged to feed the looped cable provided by the ejection gripper to the transfer unit if the looped cable is a group cable. The handling system can be designed and arranged to provide the looped twisted cable group to the following station. The handling system can be designed and arranged to feed the looped cable provided by the ejection gripper to the transfer unit, and to provide the looped twisted cable group to the following station.

The handling system can be designed and arranged to provide the looped cable to the following station if the looped cable is a single cable of the sequence.

The handling system can be set up to provide the looped cable to the following station if the looped cable is a single cable of the sequence, and to feed the looped cable provided by the ejection gripper to the transfer unit if the looped cable is a group cable, and to provide the looped twisted cable group to the following station.

The handling system can advantageously feed single cables and cable groups to the following station. The control unit can control the handling system.

The handling system can be set up to feed the looped cable provided by the ejection gripper to a bad cable area if the looped cable provided is recognized as a bad cable. The handling system can be set up to feed the looped twisted cable group to the bad cable area if the looped twisted cable group is recognized as a bad cable.

The cable processing machine can have a test module. The test module can be an optical device, for example a camera, which is set up for optical testing of the cable and/or the cable group. A cable can be identified as a bad cable using the test module.

In an embodiment, the first handling gripper is designed to feed the looped cable provided by the ejection gripper to the transfer unit, wherein the first handling gripper is designed to grip the looped cable in a first end region and to pivot the first end region so that a first transfer portion of the looped cable is formed to rest against the transfer unit, in particular wherein the first handling gripper is designed to pivot the first end region so that the first transfer portion extends along the twisting axis.

The first handling gripper can have a first pair of gripper jaws. The first gripper jaw pair can be arranged and designed to grip the looped cable in a first end region. In an embodiment, the first gripper jaw pair is pivotable. In particular, the first gripper jaw pair can be pivotable by 180°.

In an embodiment, the first gripper jaw pair can be pivoted by 180° so that the parallel cable ends oriented in the same direction point in opposite directions after pivoting and lie on the same axis. In an embodiment, the first gripper jaw pair can be pivoted by 180° in order to pivot a looped cable into a pivoted looped cable.

In an embodiment, the first handling gripper grips in the first end region and the second handling gripper grips in a second end region. The first end region and/or the second end region can be pivoted by the first and/or second handling gripper in such a way that the first cable end and the second cable end point in opposite directions. After pivoting, the first cable end can point away from the second cable end. The first end portion and/or the second end portion can be pivoted by the first and/or second handling gripper in such a way that the first cable end and the second cable end are arranged along the twisting axis. The first end region and the second end region can be pivoted by the first and/or second handling gripper such that the first cable end and the second cable end are arranged along the twisting axis and point away from one another along the twisting axis.

In an embodiment, the first handling gripper is pivotable. In an embodiment, the second handling gripper is pivotable. In an embodiment, the first handling gripper and the second handling gripper are pivotable. The first handling gripper and/or the second handling gripper can be pivotable by 180°.

In an embodiment, the first handling gripper is pivotable between a first position and a second position, wherein the first handling gripper is aligned parallel to the twisting axis in the first position and wherein the first handling gripper is aligned parallel to the twisting axis in the second position. In the first position, the first handling gripper can point in the direction opposite the direction in the second position. In an embodiment, the second handling gripper is pivotable between a first position and a second position, wherein the second handling gripper is aligned parallel to the twisting axis in the first position and wherein the second handling gripper is aligned parallel to the twisting axis in the second position. In the first position, the second handling gripper can point in the direction opposite the direction in the second position.

In an embodiment, the first handling gripper can be pivoted from the first position to the second position, with the second handling gripper remaining in the first position. In an embodiment, the handling system is designed to pivot the first handling gripper by 180° while the second handling gripper remains in the first position.

Using the first handling gripper and/or the second handling gripper, the looped cable can be pivoted into a pivoted looped cable.

In an embodiment, the first handling gripper is designed to provide the looped twisted cable group to the following station, wherein the first handling gripper is designed to grip and pivot the twisted cable group between the first twisting head and the first auxiliary gripper so that the looped twisted cable group results, in particular wherein the first handling gripper is designed to grip the twisted cable group (in particular the pivoted twisted cable group) in a first group end region and to pivot the first group end region, in particular by 180°, so that the looped twisted cable group results. In particular, the first handling gripper is designed to grip the pivoted twisted cable group in the first group end region and to pivot the first group end region by 180°.

In an embodiment, the second handling gripper is designed to provide the looped twisted cable group to the following station, wherein the second handling gripper is designed to grip and pivot the twisted cable group between the second twisting head and the second auxiliary gripper so that the looped twisted cable group results, in particular wherein the second handling gripper is designed to grip the twisted cable group (in particular the pivoted twisted cable group) in a second group end region and to pivot the second group end region, in particular by 180°, so that the looped twisted cable group results. In particular, the first handling gripper is designed to grip the twisted cable group in the first group end region and to pivot the first group end region by 180°.

In particular, the first handling gripper can pivot the first group end region by 180°. The first handling gripper can be pivotable from the second position to the first position. In particular, the second handling gripper can pivot the second group end region by 180°. The second handling gripper can be pivotable from the second position to the first position. In particular, the handling system can pivot the first and/or second group end region such that the cable ends point in the same direction. In particular, the handling system can pivot the first and/or second group end region such that the group ends (first group end and second group end) point in the same direction.

In an embodiment, the handling system has a further first handling gripper and a further second handling gripper. Advantageously, tasks within the handling system can be divided between the handling grippers. The process can advantageously be accelerated.

In an embodiment, the handling system can be arranged and designed such that the first and second handling grippers feed a cable from the ejection gripper to the transfer unit, while the further first and further second handling grippers remove a twisted cable group from the twisting station in order to feed it to the further processing station or the transfer area.

In an embodiment, the handling system can be arranged and designed such that the first and the second handling gripper are designed for the tasks relating to the production of the twisted cable group, and that the further first and the further second handling gripper are designed for the transfer of the single cables (individual cables).

According to one embodiment, the first handling gripper is arranged and designed to feed the looped cable provided by the ejection gripper to a bad cable area if the provided looped cable is recognized as a bad cable. According to one embodiment, the first handling gripper is arranged and designed to feed the looped twisted cable group to the bad cable area if the looped twisted cable group is recognized as a bad cable. The cable processing machine can have a separating plate with a deflection hook and the bad cable area, wherein the separating plate is arranged so as to feed a bad cable to the bad cable area. A bad cable is for example a damaged cable. The bad cable area can be separated from the transfer area. The bad cable area can be separated from the following station. A separation of the bad cables can advantageously be improved. A bad cable can be detected by a test unit, e.g. an optical test by an optical device.

In an embodiment, the control unit is set up to control the first handling gripper so that when a bad cable is detected, the detected bad cable is fed to the bad cable area by means of the first handling gripper. In an embodiment, the control unit is set up to control the second handling gripper so that when a bad cable is detected, the detected bad cable is fed to the bad cable area by means of the second handling gripper.

According to one embodiment, the handling system has a transfer area, wherein the transfer area is designed to feed the looped twisted cable group to the following station in accordance with the predefined sequence, wherein the transfer area has a guide plate with guide rods.

Long cables in particular can be controlled using the guide rods.

Processing Unit and/or Following Station:

In an embodiment, the processing unit is a loop layer, a cable cutter, a cable stripper, a twist remover, a grommet module, a crimp module, or a pre-orientation unit. The cable processing machine can in particular have a multiplicity of processing units. In particular, each processing unit of the multiplicity of processing units can be selected from: the loop layer, the cable cutter, the cable stripper, the twist remover, the grommet module, the crimp module, or the pre-orientation unit. In an embodiment, the cable processing machine has the loop layer, the cable cutter, the cable stripper, the twist remover, the grommet module, the crimp module, and the pre-orientation unit. The individual processing units of the multiplicity of processing units can be approached one after the other by the transport unit. The individual processing units of the multiplicity of processing units can be approached one after the other by the transport unit so that a looped cable transported by the transport unit can be fed to the processing units one after the other, and in particular can be processed one after the other by the processing units.

In an embodiment, the cable tip processing system has a first processing unit and a subsequently positioned (downstream) second processing unit. The first processing unit can be set up to carry out a first processing step on the cable. The second processing unit can be set up to carry out a downstream second processing step on the cable, in particular wherein the first processing step differs from the second processing step. For example, the first processing step can be the laying into a loop (by the loop layer) and the second processing step can be a stripping (by the cable stripper).

In an embodiment, a first cable can be fed to the first processing unit and, in particular, can be processed there and, at the same time, a second cable can be fed to the second processing unit and in particular processed there.

In an embodiment, a cable rack is positioned upstream of the processing unit, wherein the group cables are provided in the cable rack, in particular wherein the group cables and the individual cables are provided in the cable rack.

In an embodiment, the cable rack is fed by a container, in particular a multiplicity of containers. A first cable (group cable, individual cable), which is provided in the cable rack, can be provided to the cable rack from a first container. A second cable (group cable, individual cable) that is provided by the first cable and is provided in the cable rack can be provided to the cable rack from a second container different from the first container. In an embodiment, each cable (group cable, individual cable) that is provided in the cable rack is provided to the cable rack from a respective associated container. A container is for example a cable drum, a cable spool, or a cable barrel. In an embodiment, the cable rack is fed from a multiplicity of different containers.

A cable can be fed from the cable rack to the transport unit, which transports the cable to the individual processing units. A cable selection can be made from the cable rack. The control unit can control the cable selection according to the predefined sequence.

According to one embodiment, the following station is a sequence bundler. In an embodiment, the following station is a cable magazine. In an embodiment, the following station is an assembly unit. In an embodiment, the following station is a connector assembly module.

### Test Module:

In an embodiment, the cable processing machine has a test module, in particular an optical test module. The test module can be arranged and designed to monitor at least one quality feature. In an embodiment, the cable processing machine has a multiplicity of optical test modules. Each test module of the multiplicity of optical test modules can be designed to monitor a corresponding quality feature. An optical test module can be an optical device, for example a camera.

The cable processing machine can have a multiplicity of sensors. The multiplicity of these can be designed to monitor individual process steps. In an embodiment, at least one sensor is assigned to a corresponding process step. In an embodiment, a sensor of the multiplicity of sensors, in particular each sensor of the multiplicity of sensors, can report an error, for example if a quality feature is not fulfilled. Such a cable for which a fault is reported can be categorized as a bad cable, in particular categorized as a bad cable and discarded, in particular categorized as a bad cable, discarded, and produced again.

In an embodiment, the sensor, in particular the multiplicity of sensors, is associated with the cable tip processing. In an embodiment, the sensor is assigned to the cable stripper. The sensor assigned to the cable stripper can be designed to monitor that a blade of the stripper only contacts the plastic insulation of the looped cable in particular, and not the conductor of the cable. In an embodiment, the sensor is assigned to the crimp module. The sensor assigned to the crimp module can be designed to analyze the force curve of the crimping process. A deviation from a specified force curve can be an indication of a fault (e.g. missing strands, crimping of the insulation).

In an embodiment, the twisting station has a sensor, in particular a multiplicity of sensors. The sensor of the twisting station can be designed to monitor a parameter of the twisting process.

### Intermediate Storage Unit:

The cable processing machine can have an intermediate storage unit.

In an embodiment, the intermediate storage unit is arranged downstream of the processing unit. In an embodiment, the intermediate storage unit is arranged upstream of the handling system. In an embodiment, the intermediate storage unit is arranged downstream of the processing unit and upstream of the handling system. The intermediate storage unit can be designed to store a deviating looped cable.

In an embodiment, the intermediate storage unit is arranged downstream of the pre-orientation station. The intermediate storage unit can be arranged between the processing station and the handling system.

In an embodiment, the intermediate storage unit is designed so that cables can be stored in the intermediate storage unit until they are provided in the predefined sequence.

A cable that deviates from the sequence can be referred to as a deviating looped cable. A deviation between the predefined sequence and the sequence of the looped cables can be detected. If a cable is detected as a deviation from the sequence, it can be supplied to the intermediate storage unit. The deviating looped cable can be stored there, in particular until it is provided in the sequence.

The discarding of a bad cable can lead to a deviation from the predefined sequence. The bad cable cannot be processed further and would have to be produced again, which can lead to temporary deviations from the sequence.

Advantageously, deviating looped cables can be reintroduced into the process at a later time. Advantageously, the material consumption can be reduced, since deviating cables do not have to be discarded.

In an embodiment, the ejection gripper is designed to access the intermediate storage unit and to remove a stored looped cable from the intermediate storage unit and to provide it to the handling system. In an embodiment, the transport unit is designed to supply the deviating looped cable to the intermediate storage unit.

According to one embodiment, the control unit is set up to control the transport unit to feed the deviating looped cable to the intermediate storage unit when a deviation between the looped cable and the sequence has been detected.

According to one embodiment, the control unit is set up to control the ejection gripper to remove the stored looped cable from the intermediate storage unit when agreement is detected between the stored looped cable and the sequence.

### Pre-Orientation Unit:

In an embodiment, the processing unit is a pre-orientation station. The pre-orientation station can be designed to align the contact parts of a looped cable. The pre-orientation station can be designed to align the contact parts of a group cable and/or to align the contact parts of an individual cable. The contact parts can be crimped to the corresponding cable.

In an embodiment, the pre-orientation station is designed to reduce an angular error between a contact part of a group cable and the cable processing machine. In an embodiment, the pre-orientation station is designed to reduce an angular error between a contact part of an individual cable (single cable) and the cable processing machine.

The control unit can be set up to control the pre-orientation unit in order to reduce the angle error.

In an embodiment, the pre-orientation station is set up to be connected to an alignment station of a following station, in particular an assembly unit, wherein the alignment station of the following station is designed to detect the angular error between the contact part of the group cable and the cable processing machine and/or the angular error between the contact part of the individual cable and the cable processing machine, and wherein the alignment station of the following station is designed to adjust the pre-orientation station to reduce the angular error.

### Method:

According to one embodiment of the method for producing a predefined sequence of twisted cable groups by means of a cable processing machine according to the invention, the method comprises the following steps:
for each group cable of the relevant multiplicity of group cables as a looped cable in each case, a transporting step and a providing step,
wherein, in the transporting step, the looped cable is transported to the ejection gripper by means of the transport unit,
wherein, in the providing step, the looped cable is provided to the handling system,
   wherein the method further comprises the steps:
a recording step in which the multiplicity of group cables are received in the transfer unit,
a feeding step in which the multiplicity of group cables are fed as looped cables to the twisting station,
a twisting step in which the multiplicity of group cables are twisted in the twisting station to form a looped twisted cable group,
an output step in which the looped twisted cable group is fed to the following station according to the predefined sequence.

In an embodiment, before the transport step a selection step takes place in which a first cable is selected from a cable rack according to the predefined sequence.

In an embodiment, the method comprises a looping step in which a cable placed into a loop is shaped by bending the first cable.

In an embodiment, the method comprises a processing step in which a looped cable is processed by means of a processing unit. The processing step can be downstream of the looping step.

The described features of the device and/or of the method can be combined with one another. The control unit or device can be designed to control the steps described.

### DESCRIPTION OF THE DRAWINGS

Embodiments and features and advantages of the invention are explained below with reference to the figures. In the drawings:

FIG. 1 is a perspective representation of an embodiment of a cable processing machine,

FIG. 2 is a front view of an exemplary cable processing machine,

FIG. 3 is a plan view of an exemplary cable processing machine,

FIG. 4 shows schematic representations of process steps in the production of twisted cable groups,

FIG. 5A and FIG. 5B show schematic representations of steps a-f in the forwarding of twisted cable groups, and

FIG. 6 shows schematic representations of steps a-c for depositing a bad cable.

### DETAILED DESCRIPTION

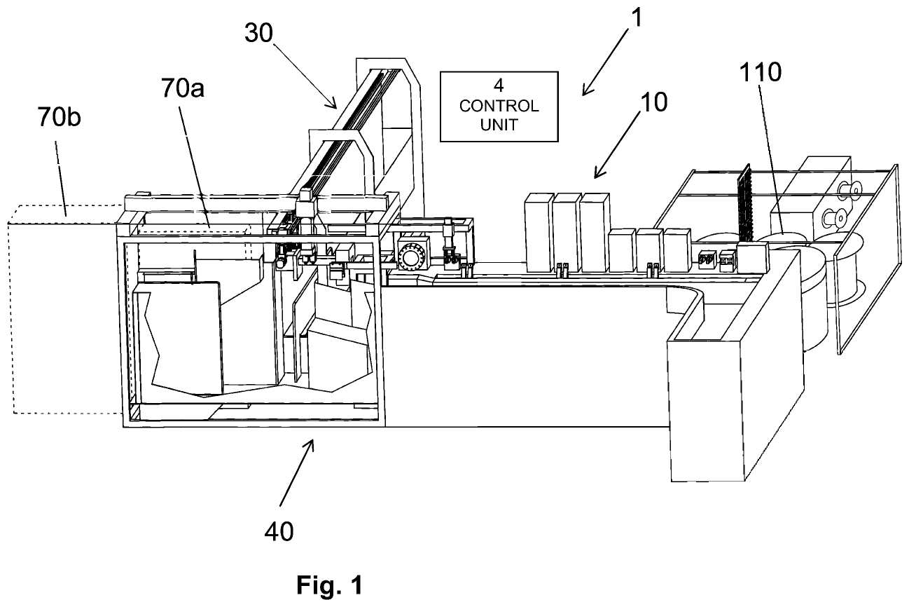

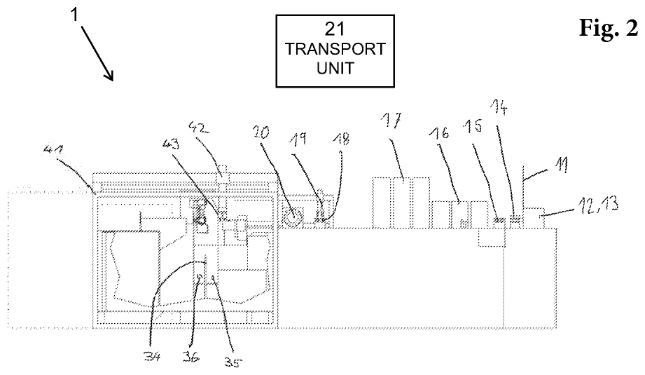

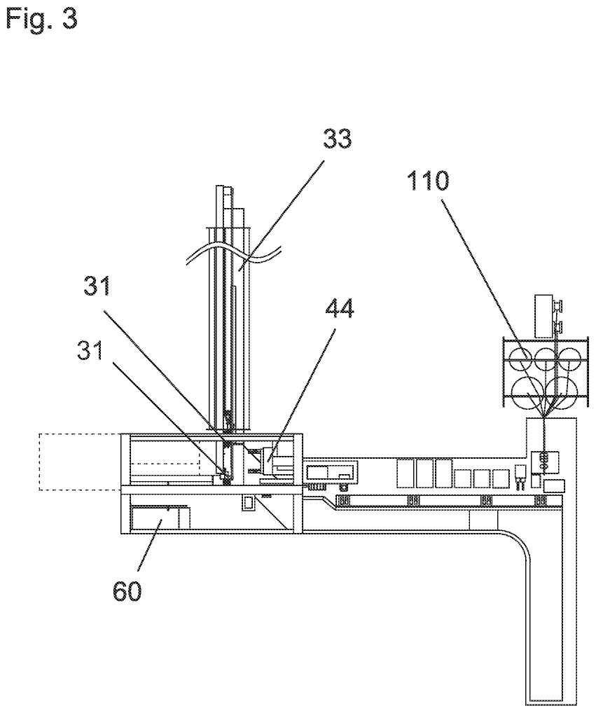

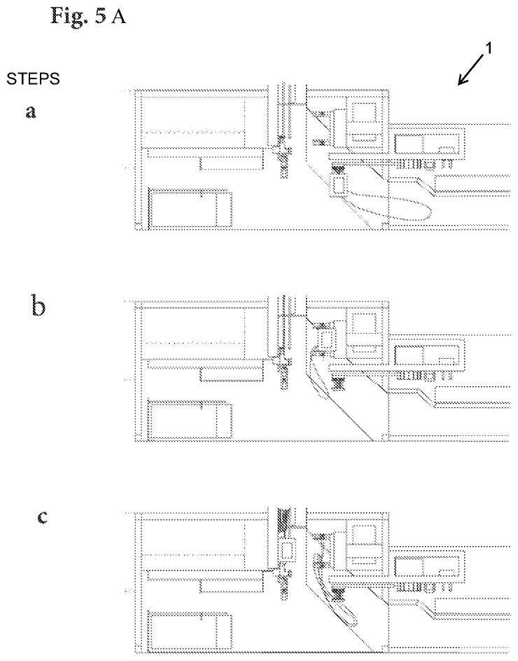

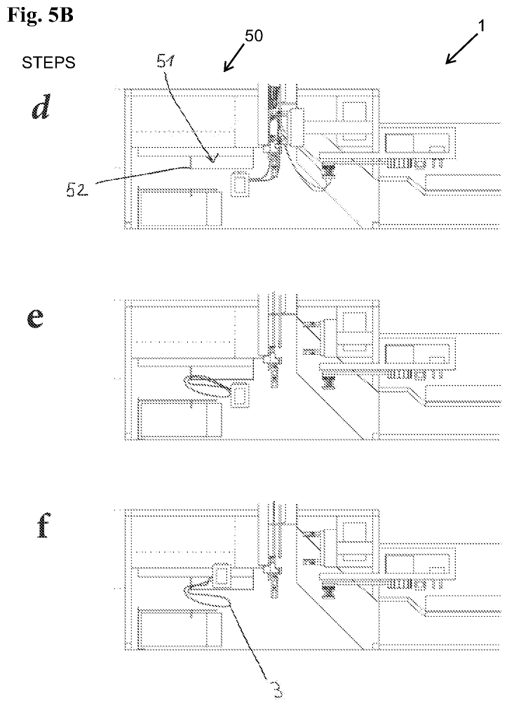

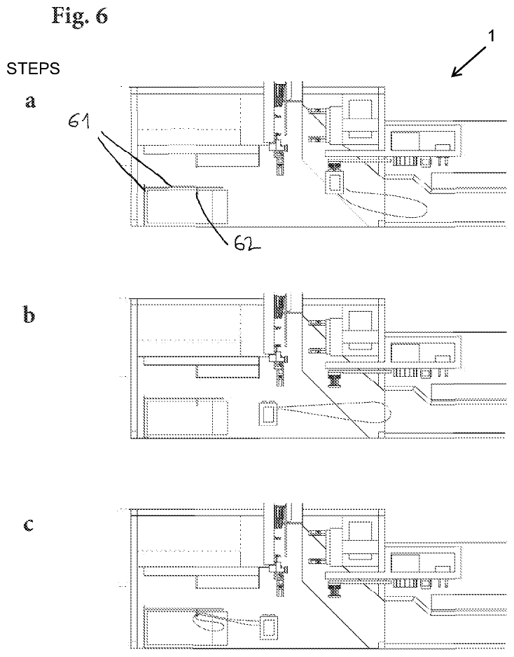

FIGS. 1 to 3 show an exemplary embodiment of a cable processing machine 1 according to the invention, in a perspective view (FIG. 1), a front view (FIG. 2), and a view from above (FIG. 3). FIGS. 5A-5B and 6 show details of the exemplary cable processing machine 1.

In the example shown, the cable processing machine 1 comprises a cable tip processing system 10, a handling system 40, and a twisting station 30 all controlled by a control unit 4. The handling system 40 can be arranged between the cable tip processing system 10 and the twisting station 30. The handling system 40 can have access to the cable tip processing system 10. The handling system 40 can have access to the twisting station 30. In particular, the handling system 40 has access to the cable tip processing system 10 and the twisting station 30.

The handling system 40 shown by way of example is made up of a support frame 41 and a handling gripper 43 (FIG. 2). In the embodiment shown, the handling gripper 43 is arranged on a gantry robot 42 (FIG. 2). In an embodiment not shown, an alternative design of the robot is realized. In an embodiment not shown, the handling system has a multiplicity of robots.

In the embodiment shown, the handling system 40 comprises a transfer unit 44 for collecting the multiplicity of group cables to be twisted and for transferring the group cables to the twisting station (twisting unit) 30 (FIG. 3). Within the exemplary handling system 40, there is a defined region for bad cables (bad cable area 60). Within the exemplary handling system 40, there is a defined region for the forwarding of the cables (transfer area 50).

The handling system 40 can have a handling region. Guide plates 51 and separating plates 61 can be provided in the handling area. The guide plates 51 and separating plates 61 can be arranged to keep cable loops under control, in particular including long cable loops. A long cable loop is to be understood, for example, as a stretched length of the loop of more than 2 m, in particular more than 3 m, in particular at least 4 m. In the exemplary embodiment, the handling region is designed to control cable loops having a stretched length of 4 m.

In the exemplary embodiment, the cable processing machine 1 has a separating plate 61 with a deflecting hook 62. The separating plate 61 with deflection hook 62 can be set up to separate bad cables from the rest of the cables. Long cables can be pulled around the deflection hook 62 so that the loop base 3 can also be pulled into the bad cable area 60 and does not interfere with the subsequent cable loops (FIG. 3, FIG. 6 steps a-c).

In an embodiment, guide plates 51 with guide rods 52 are provided in the transfer area 50. In an embodiment, both long single cables and long twisted cable groups can be pulled completely into the transfer area 50 with the aid of the guide rods 52, so that the loops of the finished cables (single cables, twisted looped cable group) do not cross with the cables to be twisted (FIG. 3, FIGS. 5A-5B steps a-f).

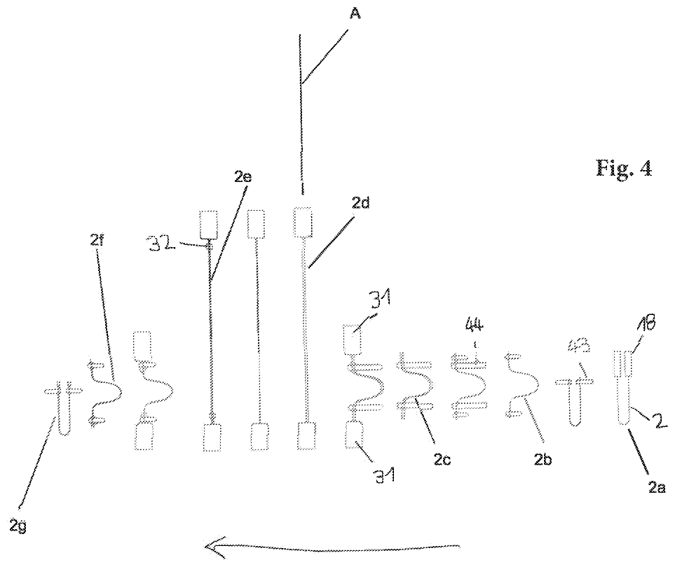

In the embodiment shown, the twisting unit 30 connected to the handling system 40 is designed to twist or strand the group cables of a cable group. At least one of the twisting heads 31 can be moved along a rail in order to stretch the group cables in a known manner. Both twisting heads 31 can be equipped with auxiliary grippers 32 to keep the end regions of the twisted cable group stretched when the twisting heads 31 are retracted (FIG. 4).

In an embodiment, the twisting station 30 is set up to carry out the steps of the method shown schematically in FIG. 4. In an embodiment, the twisting station 30 is set up and designed to receive a multiplicity of looped cables 2, 2a, in particular pivoted looped cables 2, 2b, so that a looped cable group 2, 2c results. Furthermore, the twisting station 30 can be set up to stretch the looped cable group 2, 2c. A stretched cable group 2d can advantageously be twisted easily by means of the twisting unit 30. The twisting station 30 can be designed to place the stretched twisted cable group 2e into a loop. A looped twisted cable group 2g can advantageously be provided to further processing in a particularly simple manner, in particular to a following station 70a, 70b.

The handling gripper 43 can pick up the looped cable 2, 2a, for example from the pre-orientation unit 18. The looped cable 2, 2a has a first cable end, a second cable end and an intermediate loop base 3. In particular, the first cable end and the second cable end point in the same direction. A cable end can also be referred to as a cable tip. The handling gripper 43 can be set up to grip the looped cable 2, 2a in a first end region and in a second end region.

The handling gripper 43 can be set up to pivot the first end region. The handling gripper 43 can be set up to pivot the second end region. In particular, the handling gripper 43 can pivot the first end region by 180°, so that a pivoted looped cable 2, 2b is produced. In particular, the first end region can be pivoted such that the first end region and the second end region are arranged on a common axis and the first cable end and the second cable end point away from one another. In particular, the first end region can be pivoted such that a first transfer region and a second transfer region are arranged on the common axis and the first cable end and the second cable end point away from one another. The first cable end can be pivoted away from the second cable end. The first end region and the second end region can be arranged in alignment after the pivoting. The first transfer region and the second transfer region can be arranged in alignment after the pivoting. A loop region can be located between the first end region and the second end region, in particular between the first transfer region and the second transfer region. The loop base 3 can be arranged between the first end region and the second end region, in particular between the first transfer region and the second transfer region.

In an embodiment, the handling gripper 43 can be set up to pivot the first end region and the second end region so that a pivoted looped cable 2, 2b is produced. The transfer unit 44 can be designed to receive the pivoted looped cable 2, 2b. In particular, the transfer unit 44 can receive the first transfer region of the pivoted looped cable 2, 2b and the second transfer region of the pivoted looped cable 2, 2b.

In the embodiment shown, the transfer unit 44 is set up to receive a multiplicity of pivoted looped cables 2, 2b. The multiplicity of pivoted looped cables 2, 2b can also be referred to as a looped cable group 2, 2c. In the example shown, the looped cable group 2, 2c comprises two cables 2. In particular two pivoted looped cables 2b. A cable group of two cables can also be referred to as a cable pair.

In the exemplary embodiment shown, the transfer unit 44 is set up to receive each of the first transfer areas of the group cables. In the exemplary embodiment shown, the transfer unit 44 is set up to receive the corresponding first transfer regions of the pivoted looped cables 2, 2b. In the exemplary embodiment shown, the transfer unit 44 is set up to receive the corresponding second transfer regions of the group cables.

The transfer unit 44 can further be set up to provide the looped cable group 2, 2c to the twisting heads 31. The twisting heads 31 can be designed to receive the looped cable group 2, 2c. The first twisting head 31 can be arranged opposite the second twisting head 31. The twisting heads 31 can engage at the cable ends, in particular the group ends. The first twisting head 31 can receive the first cable ends of the group cables (first group ends). The second twisting head 31 can receive the second cable ends of the group cables (second group ends). The looped cable group 2, 2c can be arranged, for example clamped, between the two twisting heads 31.

The twisting station 30 can be set up to move the twisting heads 31. At least the first twisting head 31 can be movable in relation to the second twisting head 31. The first twisting head 31 can be moved away from the second twisting head 31 so that the distance between the two twisting heads 31 can be increased. In the example shown, the distance between the two twisting heads 31 is increased. The looped cable group 2, 2c arranged in the twisting heads 31 can thereby be stretched so that a stretched cable group 2, 2d results. The group cables 2 of the stretched cable group 2, 2d can run parallel to one another. The group cables 2 of the stretched cable group 2, 2d can extend along the twisting axis A.

The twisting heads 31 can be set up to twist (or strand) the cables 2 (group cables) of the stretched cable group 2, 2d, so that a stretched twisted cable group 2, 2e results. The twisting station 30 can have an auxiliary gripper 32. The twisting station 30 can have a multiplicity of auxiliary grippers 32. In the embodiment shown, the twisting station 30 has two auxiliary grippers 32. In the embodiment shown, each twisting head 31 is assigned an auxiliary gripper 32; in particular, a respective auxiliary gripper 32 is arranged on each twisting head 31. The first auxiliary gripper 32 can be set up to grip the stretched twisted cable group 2, 2e at a first auxiliary distance from the first twisting head 31. The second auxiliary gripper 32 can be set up to grip the stretched twisted cable group 2, 2e at a second auxiliary distance from the second twisting head 31.

The distance between the twisting heads 31 can be reduced in order to produce a pivoted looped twisted cable group 2, 2f. The first twisting head 31 can be moved in the direction of the second twisting head 31, in particular along the twisting axis A. In the embodiment shown, the region between the first twisting head 31 and the first auxiliary gripper 32 is held along the twisting axis A when the distance between the twisting heads 31 is reduced. In the embodiment shown, the region between the second twisting head 31 and the second auxiliary gripper 32 is held along the twisting axis A when the distance between the twisting heads is reduced. The loop base 3 (of the cable group) can be formed between the two auxiliary grippers 32.

The handling gripper 43 can be set up to grip the region of the cable group between the first twisting head 31 and the first auxiliary gripper 32. The handling gripper 43 can be set up to grip the region of the cable group between the second twisting head 31 and the second auxiliary gripper 32. Advantageously, the handling gripper 43 can be applied particularly easily to these regions, which extend along the twisting axis A. The handling can advantageously be facilitated.

The twisting station 30 can be designed to remove the twisting heads 31 and the auxiliary grippers 32 from the pivoted looped twisted cable assembly 2, 2f when the handling gripper 43 has gripped the pivoted looped twisted cable assembly 2, 2f. The handling gripper 43 can pivot the pivoted looped twisted cable group 2, 2f in order to produce the looped twisted cable group 2, 2g. In particular, the handling gripper 43 is designed to pivot the end regions of the swiveled, looped, twisted cable group 2, 2f such that the first group end and the second group end point in the same direction. The looped twisted cable group 2, 2g can be provided for subsequent further processing.

In an embodiment, a support tray 33 is arranged under the twisting unit 30. The support tray 33 can be divided at its entrance into a first channel 35 and a second channel 36 by a separating element 34 (FIG. 2). The loops of the cables 2, which are clamped by the transfer unit 44 in the twisting heads 31 and are stretched for twisting, can move in the first channel 35. The loop of the finished (looped) twisted cable group can move in the second channel 36 and can be removed by the handling gripper 43. By means of the separating element 34, the method steps “clamping the new (untwisted) cable group” and “removing the finished (twisted) cable group” can advantageously overlap, in particular can overlap in time. Advantageously, it is not necessary to wait for the twisted cable group to be completely removed before reloading the twisting unit 30. The method can advantageously be accelerated. Advantageously, the efficiency can be increased.

In an embodiment, in the transfer region 50 of the handling system 40 the cables can be transferred to a known following station 70a, 70b. A following station 70a, 70b can be, for example, a sequence bundler, a cable magazine, or a connector assembly module (FIG. 1). A container 110 can be provided to the cable processing machine 1. The container 110 can, for example, be a cable barrel. In the embodiment shown as an example, a multiplicity of containers 110 are provided. The containers 110 can feed the cable rack 11.

The cable processing machine 1 can be designed to produce a sequence of twisted cable groups. The cable processing machine 1 can be designed to produce a sequence of twisted cable groups and single cables. For the production of twisted/stranded cable groups, the first corresponding cable 2 (also referred to as group cable) can be selected from a cable rack 11 and formed into a loop of the desired length, so that a looped cable results. The cable can be laid in a loop using a loop layer 12. In a subsequent step of an embodiment of the method, processing steps follow which can be carried out by processing units also referred to as processing stations. A processing step can be removing the twist, stripping insulation, applying grommets, or crimping the contact parts. A processing station can be a cable cutter 13. A processing station can be a cable stripper 14. A processing station can be a twist remover 15. A processing station can be a grommet module 16. A processing station can be a crimping module 17. In the example shown, the cable tip processing system has the loop layer 12, the cable cutter 13, the cable stripper 14, the twist remover 15, the grommet module 16, and the crimping module 17. In the example shown, these processing stations are arranged one after the other.

The looped cable 2, 2a can be moved with a transport unit 21 from a first processing station to a second, downstream processing station. Advantageously, both cable ends of the looped cable pointing in the same direction can be processed particularly easily by the processing stations. In the example shown, all processing stations can be approached one after the other by the transport unit 21.

The cable processing machine 1 can have a pre-orientation unit 18 (FIG. 2). The pre-orientation unit 18 can be a processing station. The pre-orientation unit 18 can be arranged downstream of the crimping module 17. In an embodiment of the method, the next step is formed by the pre-orientation unit 18. The pre-orientation unit 18 can be designed to rotate the cable tips (cable ends) about their longitudinal axis. Advantageously, in this way the basic alignment of the cable ends and the contact parts can be changed (e.g. 0°, 0°, 0°, 180°, . . . ). In particular, in this way the alignment before the actual fitting of a connector housing can advantageously be substantially simplified. The manufacturing process can be simplified and accelerated.

In an embodiment of the method, after the pre-orientation the ends of the group cable are taken over by an ejection gripper 19 and provided to the handling gripper 43. The handling gripper 43 can move the looped cable (group cable or individual cable) to the transfer unit 44 (FIG. 4). In an embodiment, the cable ends running in parallel are spread apart by the handling gripper 43 so that the cable ends become aligned and point in opposite directions.

In an embodiment, a second cable is processed in the same way and brought into the transfer unit. If both cables (group cables) for the cable group to be twisted are arranged in the transfer unit, the group cables can be transferred to the twisting unit (or stranding unit).

In an embodiment of the method, the twisting heads 31 (also referred to as twisting grippers) of the twisting unit 30 receive the cable ends and pull the cable loops to the stretched length, and the twisting or stranding process is started (FIG. 4). After this step, short adhesive tape pieces or the like can be attached in a known manner as needed to secure the twisted cable (twisted cable group).

According to the exemplary embodiment of the method, before the cable ends are brought together to form a loop again, the auxiliary grippers 32 grip the stretched cable (stretched twisted cable group 2, 2e) (FIG. 4). The auxiliary grippers 32 here hold a region just after the twisting grippers 31, while the twisting grippers/twisting heads 31 move together. The handling gripper 43 can now remove the cable (the cable group) without difficulty, even if the open ends (the untwisted ends) are kept short. The handling can advantageously be simplified.

In order to be able to process short open ends, the auxiliary grippers 32 (also referred to as additional grippers) can be provided with the twisting grippers 31. These additional grippers 32 can hold a small part of the twisted cable (twisted cable group) in position when the twisting heads 31 are moved together along the twisting axis A. The handling gripper 43 can now grip the twisted cable (twisted cable group) at a defined position (in particular grip, take over, and pass on).

The handling gripper 43 can pivot the first cable end back, in particular by 180°, so that the first cable end and the second cable end are again parallel next to each other (twisted looped cable group). The twisted looped cable group can be transferred to a following station 70a, 70b (also referred to as a processing station) in the transfer area 50 (e.g. a sequence bundler, a cable magazine, or an assembly unit). The handling gripper 43 can pivot the cable ends back so that they are parallel to each other again (twisted looped cable group) and can transfer them to a following station 70a, 70b (also referred to as processing station) in the transfer area 50 (e.g. a sequence bundler, a cable magazine, or an assembly unit). In an embodiment, a collecting station is connected downstream of the handling system 40. In an embodiment, a connector assembly station is arranged downstream of the handling system 40. Single cables and/or twisted cable groups can be fed from the cable processing machine 1 to the connector assembly station. In particular, single cables and twisted cable groups can be fed in looped form to a following station 70a, 70b.

In an embodiment, single cables that are not to be processed to form a twisted cable (twisted cable group) skip over the part (i.e. the steps) of the transfer unit 44 and the twisting unit 30. A single cable can be provided to the following station 70a, 70b after the cable tip processing system 10.

In an embodiment, it is provided that the transfer of long cables in the transfer area 50 also includes a preceding tightening of the cable loop with the aid of the guide rods 52.

Cables with faults (damage, defects) in the processing can be moved by the handling gripper 43 to the bad cable area 60 (FIG. 6).

In an embodiment, an intermediate storage 20 for cables is arranged after the pre-orientation module 18 (FIG. 2). In the case of slow production, it is possible to wait until one cable has completely passed through all stations before the next cable starts the process. However, in order to achieve better utilization of the stations, the cables can be transported continuously to the next processing station in a known manner. The production process is therefore advantageously accelerated. In a case in which a cable is recognized as faulty, it must be produced again and brought to the correct location in the sequence. The intermediate storage unit 20 can make it possible to skip over a previous cable (a cable that has a previous position in the sequence, also referred to as upstream position) in the intermediate storage unit 20 without sacrificing it. Advantageously, deviations from the sequence can be corrected without having to remove cables already produced. The material outlay can advantageously be reduced. The time outlay can advantageously be reduced.

In an embodiment, for the replacement production of bad cables the intermediate storage unit (also known as the cable intermediate storage unit) is provided at the beginning of the auxiliary station. The cables produced again can thus overtake other cables in the process so that the order of the sequence is maintained.

In a further embodiment, the pre-orientation station 18 enables the operator to reduce or even eliminate a recurring angular error of the contact parts. If, for example, a deviation of 10° always occurs for a cable-contact part combination, this can be remedied using the pre-orientation station 18. To achieve an alignment of 180°, for example, a correction only by 170° can be made. In an embodiment, an alignment station of a connected assembly unit can communicate with the pre-orientation station 18 and can itself carry out corrections of the angular error. In an embodiment, the pre-orientation station 18 and/or the alignment station of a connected assembly unit are set up so as to correct a gradually increasing angular error. In an embodiment, the cable processing machine 1 is set up to send an error message to the operator when an angular error is detected, in particular stating that the processing station in question has to be checked.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A cable processing machine for producing a predefined sequence of twisted cable groups, wherein the cable processing machine comprises:
a cable tip processing system adapted to process a cable into a looped cable;
a handling system;
a twisting station;
a control unit controlling the cable tip processing system, the handling system and the twisting station;
wherein the cable tip processing system includes a processing unit, an ejection gripper, and a transport unit, the transport unit being adapted to move the looped cable from the processing unit to the ejection gripper, wherein the ejection gripper provides the looped cable to the handling system;
wherein the handling system includes a transfer unit that receives a plurality of looped cables including the looped cable from the ejection gripper, the plurality of looped cables forming a looped cable group, and
wherein the handling system feeds the looped cable group to the twisting station;
wherein the twisting station receives and twists the looped cable group to form a looped twisted cable group;
wherein the control unit assigns a respective multiplicity of cables for each of the twisted cable groups of the predefined sequence and controls the cable processing machine such that, for each of the cables, the cable is formed by the processing unit as a looped cable, the looped cable is moved by the transport unit from the processing unit to the ejection gripper, the ejection gripper provides the looped cable to the handling system where the looped cable is received by a transfer unit, the transfer unit supplies the looped cable with other looped cables to the twisting station wherein the looped cables are twisted to form one of the twisted cable groups as a looped twisted cable group, and the handling system then feeds the looped twisted cable group to a following station according to the predefined sequence.

2. The cable processing machine according to claim 1 wherein the predefined sequence includes producing a single cable looped cable, wherein the handling system is adapted to feed the single cable looped cable to the following station, wherein the control unit is configured to assign an individual cable of the multiplicity of cables as the single cable and to control the cable processing machine to move the single cable looped cable by the transport unit from the processing unit to the ejection gripper, provide the single cable looped cable to the handling system by the ejection gripper, and feed the single cable looped cable to the following station according to the predefined sequence.

3. The cable processing machine according to claim 1 wherein the twisting station includes a first twisting head and a second twisting head, wherein the first twisting head rests against a first end region of the looped cable group and the second twisting head rests against a second end region of the looped cable group, wherein the first twisting head and the second twisting head are arranged along a twisting axis, and wherein the first twisting head is movable in relation to the second twisting head along the twisting axis such that a head spacing between the first twisting head and the second twisting head is selectively variable.

4. The cable processing machine according to claim 3 wherein the looped cable group becomes a stretched cable group at a predetermined head spacing, wherein the twisting station twists the stretched cable group into a stretched twisted cable group, wherein the twisting station has a first auxiliary gripper adapted to grip the stretched twisted cable group at a first auxiliary distance from the first twisting head, wherein the twisting station holds the stretched twisted cable group between the first twisting head and the first auxiliary gripper along the twisting axis when the head spacing between the first twisting head and the second twisting head is reduced to form the stretched twisted cable group into the looped twisted cable group.

5. The cable processing machine according to claim 1 including a separating element arranged between a first channel and a second channel, wherein the first channel is arranged such that the looped cable group is fed to the twisting station through the first channel, and the second channel is arranged such that the looped twisted cable group is removed from the twisting station through the second channel.

6. The cable processing machine according to claim 1 wherein the handling system has a first handling gripper adapted to at least one of:
feed the looped cable provided by the ejection gripper to the transfer unit;
provide the looped twisted cable group to the following station;
feed the looped cable provided by the ejection gripper to a bad cable area when the provided looped cable is recognized as a bad cable; and
feed the looped twisted cable group to the bad cable area when the looped twisted cable group is recognized as a bad cable.

7. The cable processing machine according to claim 6 wherein the first handling gripper is adapted to feed the looped cable provided by the ejection gripper to the transfer unit, the first handling gripper being adapted to grip the looped cable in a first end region and to pivot the first end region such that a first transfer portion of the looped cable is formed to rest against the transfer unit, and wherein the first handling gripper is adapted to pivot the first end region such that the first transfer portion extends along a twisting axis.

8. The cable processing machine according to claim 7 wherein the first handling gripper is adapted to provide the looped twisted cable group to the following station, the first handling gripper being adapted to grip and pivot the pivoted twisted cable group between a first twisting head and a first auxiliary gripper such that the looped twisted cable group results, wherein the first handling gripper is adapted to grip the pivoted twisted cable group in a first group end region and to pivot the first group end region so that the looped twisted cable group results.

9. The cable processing machine according to claim 6 wherein the first handling gripper is adapted to feed the looped cable provided by the ejection gripper to the bad cable area when the provided looped cable is recognized as a bad cable and/or to feed the looped twisted cable group to the bad cable area when the looped twisted cable group is recognized as a bad cable, wherein the cable processing machine includes a separating plate with a deflection hook and the bad cable area, and wherein the separating plate is arranged to feed the bad cable to the bad cable area.

10. The cable processing machine according to claim 1 including an intermediate storage unit arranged downstream of the processing unit and/or upstream of the handling system, wherein the intermediate storage unit is adapted to store a looped cable that deviates from the predefined sequence.

11. The cable processing machine according to claim 10 wherein the ejection gripper is adapted to access the intermediate storage unit, to remove a stored looped cable from the intermediate storage unit, and to provide the removed looped cable to the handling system, and/or wherein the transport unit is adapted to supply a looped cable that deviates from the predefined sequence to the intermediate storage unit.

12. The cable processing machine according to claim 10 wherein the control unit controls the transport unit to feed the looped cable that deviates to the intermediate storage unit when a deviation between the looped cable that deviates and the predefined sequence is detected, and/or wherein the control unit controls the ejection gripper to remove the stored looped cable from the intermediate storage unit when agreement is detected between the stored looped cable and the predefined sequence.

13. The cable processing machine according to claim 1 wherein the processing unit is a pre-orientation station adapted to reduce an angular error between a contact part of a cable of the looped cable group and the cable processing machine, and/or wherein the pre-orientation station is adapted to reduce an angular error between a contact part of an individual cable and the cable processing machine.

14. The cable processing machine according to claim 13 wherein the pre-orientation station is connected to an alignment station of the following station, wherein the alignment station detects the angular error between the contact part of the cable of the looped cable group and the cable processing machine, and/or between the contact part of the individual cable and the cable processing machine, and wherein the alignment station of the following station is adapted to adjust the pre-orientation station to reduce the angular error.

15. A method for producing a predefined sequence of twisted cable groups using the cable processing machine according to claim 1, the method comprising the steps of:
for each looped cable of a multiplicity of looped cables performing a transporting step and a providing step;
wherein, during the transporting step, the looped cable is transported to the ejection gripper by the transport unit;
wherein, during the providing step, providing the looped cable to the handling system from the ejection gripper;
recording the multiplicity of the looped cables received in the transfer unit;
feeding the multiplicity of looped cables to the twisting station;
twisting the multiplicity of looped cables in the twisting station thereby forming a looped twisted cable group; and
outputting the looped twisted cable group to the following station according to the predefined sequence.
